(19) United States
(12) Patent Application Publication
(10) Pub. No.: US 2012/0291348 A1
(43) Pub. Date: Nov. 22, 2012

(54) SOIL MOISTURE RETENTION METHOD

(76) Inventors: Denis A. Hood, Marlton, NJ (US); James M. Cucinotta, Marlton, NJ (US)

(21) Appl. No.: 13/480,566

(22) Filed: May 25, 2012

Related U.S. Application Data
(63) Continuation-in-part of application No. 12/589,774, filed on Oct. 28, 2009, now abandoned.

(51) Int. Cl. A01G 1/00

(52) U.S. Cl. 47/58.1 SC

(57) ABSTRACT

A method of soil retention uses a soil additive that increases water retention of basic potting soil. The soil additive, either premixed with or added to soil, is biodegradable, ultra-absorbent, and generally safe for the environment. When water is added to the soil additive mixture, moisture is retained within the additive to be disbursed throughout the soil and thereby to the plant within the soil, over a prolonged period of time, e.g. fourteen days to twenty eight days, depending on ambient conditions and the plant.

This application claims the benefit of U.S. application Ser. No. 12/589,774, filed on Oct. 28, 2009.

### BACKGROUND OF THE INVENTION

Routine and periodic watering of flowers, bushes, shrubs, vines, and generally all types of plant life is required to insure healthy, consistent growth. Too often, however, plants are neglected, due to the frequency required to continually water and maintain them. Depending on ambient environmental conditions, plants, especially house plants, require watering as often as every week. Failure to adequately water will result in poor growth and, ultimately, dying vegetation.

There are various systems and methods which claim to promote plant growth, but none which specifically and effectively address maintaining moisture in the plant's growing medium. For instance, the system disclosed in U.S. Pub. No. 2009/0320367 is concerned with the growth of plants, yet it is directed to growth in different soil layers. Nothing is disclosed in this system regarding enhanced moisture absorption. The growth medium which is utilized is simply potting soil comprising various perceived plant materials.

The implementation of a process which prolongs the period of time needed between watering would be of great benefit in insuring that plant life is kept properly moist and conscientiously cared for over time. There are currently no soil additives which act to improve moisture retention within the soil to provide the many benefits of moisture retention, as discussed hereinafter.

### SUMMARY OF THE INVENTION

It is thus the object of the present invention to provide a method of soil moisture retention which uses a soil additive that increases water retention of basic potting soil. The soil additive, either premixed with or added to soil, is biodegradable, ultra-absorbent, and generally safe for the environment. When water is added to the soil additive mixture, moisture is retained within the additive to be disbursed throughout the soil and thereby to the plant within the soil, over a prolonged period of time, e.g. fourteen days to twenty eight days, depending on ambient conditions and the plant.

It is another object of the present invention to provide a soil moisture retention method which generally reduces the frequency of watering.

It is another object of the present invention to provide a soil moisture retention method which employs the use of an ultra-absorbent, biodegradable additive to plant potting soil.

It is another object of the present invention to provide a soil moisture retention method which initiates faster growth of plants in a soil additive growth environment.

It is another object of the present invention to provide a soil moisture retention method which allows for faster incubation of seedlings.

It is another object of the present invention to provide a soil moisture retention method which stimulates more natural root growth.

It is another object of the present invention to provide a soil moisture retention method which reduces soil rot as defined by the top layer of crusted soil, while underneath, soil is overwatered.

It is another object of the present invention to provide a soil moisture retention method which acts as a time release to even out water moisture in the soil.

It is another object of the present invention to provide a soil moisture retention method which improves soil oxidation by keeping soil from compressing through the lack of moisture.

It is another object of the present invention to provide a soil moisture retention method which reduces standing water at the base of a container due to hardness of soil.

It is another object of the present invention to provide a soil moisture retention method which allows for plants to be grown in dryer climates.

It is another object of the present invention to provide a soil moisture retention method which reduces the need for vermiculate in soil.

It is another object of the present invention to provide a soil moisture retention method which allows plants to be grown further away from water sources.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a schematic representation showing the method of soil moisture retention of the present invention.

FIG. 2 is an enlargement taken from FIG. 1.

### DETAILED DESCRIPTION OF THE INVENTION

Moisture is retained within soil 2 in a container, for example, planting pot 4, by moisture retention additives 6. Each additive 6 comprises material which is ultra-absorbent, biodegradable, and generally safe for the environment. Additives 6 are capable of absorbing and retaining moisture for a prolonged period of time, in moisture friendly environments. It is contemplated that material such as cotton chamois and similar cotton absorbing material, or equivalents would be used. Optimally, additives 6 comprise separate pieces of the absorbent material approximately one half inch square. The invention is not, however, to be considered restricted to pieces of this shape and size.

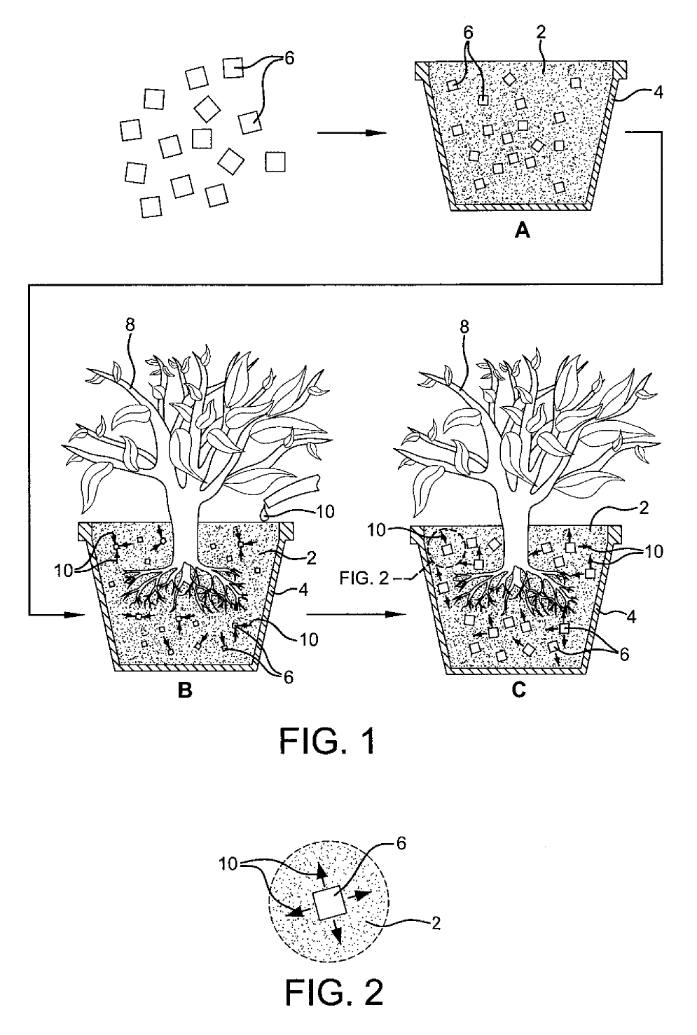

Additives 6 are evenly mixed throughout soil 2 in pot 4, as seen in FIG. 1A. It has been found that an approximate 15 to 1 soil to additive ratio works well, although this ratio can be altered based on variables such as the water requirement of the plant and soil characteristics.

Following the planting of flowers, bushes, vines, or other plant life 8, water 10 is added to soil 2. The added water 10 is absorbed by additives 6, as seen in FIG. 1B. Once water is absorbed, additives 6 expand appreciably, both in size and weight. (See FIG. 1C). This creates a soil additive mixture which holds significantly more water than normal watered soil.

Over prolonged periods of time, e.g. from two to four weeks, depending on ambient conditions and plant characteristics, additives 6 disburse their absorbed water into soil 2. See FIGS. 1C and 2. The slow but constant dispersion of water from additives 6 serves to maintain a high moisture content within the soil and ensures that plants growing therein will be adequately watered over time.

Tests of the additives of the present invention in potting soil have confirmed the positive results of using the additives and the present method. A mixture of potting soil and additives were compared to potting soil without the additives. As seen in the following table, almost 50% more water could be added to Sample B (the potting soil plus the additive) than Sample A (no additive) before saturation was reached, saturation weight of Sample B being 58 ounces verses a saturation weight of Sample A of 40 ounces. Over a two week period, the soil and additive mixture (Sample B) retained approximately 20% more of its original weight, mostly water, than the soil without the additive (Sample A).

SOIL ADDITIVE TEST RESULTS

| | |
|---|---|
| | SAMPLE B |
| SAMPLE A | (Potting Soil |
| (Potting Soil) | Plus Additive) |

| | | | | |
|---|---|---|---|---|
| Tare Wt | 2.75 | oz. | 2.75 | oz. |
| Soil Volume | 3.5 | pts. | 3.5 | pts. |
| Soil Weight | 1 lb. | 3.75 oz. | 1 lb. | 3.75 oz. |

| | | | |
|---|---|---|---|
| Additive sq. in. | 0 | 85 | sq. in. |
| Additive wt. | 0 | <1 | oz. |

| | | | | |
|---|---|---|---|---|
| Saturation Weight | 40 | ozs. | 58 | ozs. |
| Water Weight | 18 | ozs. | 34 | ozs. |
| Weight Day 1 | 3 lbs. | 1.5 ozs. | 4 lbs. | 1.5 ozs. |
| Day 2 | 3 lbs. | .5 ozs. | 4 lbs. | 1.12 ozs. |
| Day 3 | 2 lbs. | 15.5 ozs. | 4 lbs. | .38 ozs. |
| Day 4 | 2 lbs. | 14.5 ozs. | 3 lbs. | 15.62 ozs. |
| Day 5 | 2 lbs. | 13.62 ozs. | 3 lbs. | 15 ozs. |
| Day 6 | 2 lbs. | 12.75 ozs. | 3 lbs. | 14.62 ozs. |
| Day 7 | 2 lbs. | 12 ozs. | 3 lbs. | 14 ozs. |
| Day 8 | 2 lbs. | 11.12 ozs. | 3 lbs. | 13.4 ozs. |
| Day 9 | 2 lbs. | 10.3 ozs. | 3 lbs. | 12.7 ozs. |
| Day 10 | 2 lbs. | 9.5 ozs. | 3 lbs. | 12.12 ozs. |
| Day 11 | 2 lbs. | 8.75 ozs. | 3 lbs. | 11.5 ozs. |
| Day 12 | 2 lbs. | 8 ozs. | 3 lbs. | 10.8 ozs. |
| Day 13 | 2 lbs. | 7.4 ozs. | 3 lbs. | 10.12 ozs. |
| Day 14 | 2 lbs. | 6.75 ozs. | 3 lbs. | 9.48 ozs. |

This testing shows that soil enhanced with the proper amount of additives demonstrated a significant improvement in its ability to hold water by weight. In addition, soil treated by the method of the present invention has demonstrated approximately twelve percent slowing in evaporation, when measured with a moisture meter.

Testing of flowering plants and cherry tomatoes over a four week period, utilizing the method of the present invention as compared to growth in normal potting soil, resulted in the following:

| | SOIL ADDITIVE | |
|---|---|---|
| | MIXTURE | SOIL ONLY |
| Growth: | 18″ to 24″ | 18″ to 21″ |
| New Sprouts: | 60 | 24 |
| Height: | 28″ | 21″ |
| Color: | deeper pinks and greens | muted coloring |
| Physical | bigger, bushier, healthier | less dense, sparse flower- |
| Appearance: | | ing |
| Roots: | faster growth into the soil | stayed nearer the surface |
| | thicker, more plentiful, | of the pot |
| | transplanting required | never went deep into the |
| | | soil |
| Vegetation | 75 from a single plant | 40 from a single plant |
| Yield | | |
| (Tomatoes): | | |
| Vegetation | fuller size and shape | did not achieve red color |
| Weight | redder color | |
| (Tomatoes): | | |
| Speed of | visible growth at 7 days | visible growth at 17 days |
| Maturity | first yield at 26 days | first yield at 38 days |
| (Tomatoes): | | |

The results of this testing clearly reflect a marked improvement in all phases of plant growth, when the method of the present invention is employed and compared with customary growing practices. Plants grow taller, deploy far more sprouts, are healthier, have stronger roots, and yield much greater and richer vegetation.

Further test results have shown that utilizing one half inch square material additives in potting soil, in a soil to soil additive ratio of 15 to 1, results in at least from five to ten times more water than is contained in potting soil with no additives. This results in maintenance of moisture in the potting soil for a period of time at least five to ten times longer than potting soil containing no additives.

The moisture retention method of the present invention also provides prolonged moisture feed capability to improve the ability to transport living plants long distances. In addition, plants can endure “retail” selling environments more readily, thus reducing plant allowances for vendors and lower markdowns for retailers. Product appearance clearly will be enhanced resulting in higher sales as well.

Other benefits of the method of the present invention include a significant improvement in soil stability. Plants in this soil additive mixture will endure stronger winds in external environments. Plants also show a drastic improvement in water dispersion in all altitudes. In addition, plants with more superficial root systems greatly benefit from being planted in the soil additive mixture. The soil additive mixture greatly reduces soil compaction, thus increasing oxygen levels in soil, resulting in healthier plants. Finally, since the method disclosed herein efficiently keeps the soil and the roots moist, more fertilizer will be activated and so less fertilizer will be required for plant growth.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. The method of increasing moisture retention in potting soil comprising the steps of:
providing a plurality of separate pieces of biodegradable, moisture absorbent, environmentally friendly soil additives, said additives comprising pieces of cotton material approximately one-half inch square;
providing a given volume of potting soil;
combining the soil additives and potting soil by adding the soil additives to the potting soil;
mixing the soil additives substantially evenly throughout the volume of potting soil;
planting one or more growing plants within the potting soil;
adding water to the potting soil;
absorbing moisture from the water into the soil additives;
expanding the size of the soil additives due to the absorption of the water;
retaining the moisture within the soil additives, thus creating a soil additive mixture containing at least five to ten times more water than is contained in potting soil with no additives;
disbursing moisture from the soil additives to the potting soil and to the plants over a prolonged period of time; and
maintaining moisture in the potting soil for said prolonged period of time and for a period of time at least five to ten times longer than potting soil containing no additives.

2. The method of claim 1 wherein the potting soil to soil additive ratio is 15 to 1.
